(19) United States
(12) Patent Application Publication
(10) Pub. No.: US 2019/0261588 A1
(43) Pub. Date: Aug. 29, 2019

(54) PLANT GROWTH SYSTEM WITH ROOT BARRIER

(71) Applicant: SAINT-GOBAIN CULTILENE B.V., Tilburg (NL)

(72) Inventors: Kim Harding, Tilburg (NL); Bonefacius Johannus Petrus Heeren, Tilburg (NL); Jan-Willem Spaargaren, Tilburg (NL)

(21) Appl. No.: 16/343,078

(22) PCT Filed: Oct. 23, 2017
(86) PCT No.: PCT/NL2017/050691

§ 371 Date: Apr. 18, 2019

(30) Foreign Application Priority Data
Oct. 21, 2016 (NL) 2017652

(51) Int. Cl. A01G 31/02; A01G 27/00

(52) U.S. Cl. CPC A01G 31/02; A01G 27/006

(57) ABSTRACT

The invention provides a plant growth system comprising growing substrates (110; 206; 306) as well as plants (P) of which the roots (R) grow in the growing substrate, a number of holding bodies (100; 202; 301) each having a bottom (101; 224; 324) and at least one bottom spacer (104, 105; 9b; 309b), the at least one bottom spacer at the upper side thereof supporting a growing substrate thereon such that a distance is maintained between the bottom and the growing substrate, —irrigation means (331) for supplying water to the roots of the plants, —drainage means having a drainage opening (241; 341) in the bottom as well as a common drainage which is in communication with each of the drainage openings for allowing water supplied by the irrigation means to the plants to drain via the drainage opening to the common drainage, —a water permeable root barrier (123; 205; 305) for each holding body wherein the at least one root barrier is positioned below the upper side of the at least one bottom spacer, upstream of the common drainage for allowing passing of water throught the root barrier to the common drainage but preventing the roots from penetrating throught the root barrier in the common drainage.

The invention relates to a plant growth system. The invention further relates to a method for growing plants, in particular growing plants in a greenhouse, as well as a greenhouse provided with the system, and a holding body and a growing substrate for use in the system to according to the invention.

Known plant growth systems are used to provide a nutritious liquid to the plant. These known systems comprise a plurality of bag-like holding bodies, each of which having a growing substrate therein. The substrate is typically formed out of stonewool, glasswool or wood fiber. In order to grow plants, the bag with the growing substrate is placed on a gutter, after which an opening is cut in the upper side of the bag-like holding body. Through the opening, a propagation substrate having a plant growing therein is placed onto the growing substrate. Often the growing substrate is hydrated with water for a few days before placing the propagation substrate onto the substrate in order to saturate the growing substrate within the bag-like holding body. After the growing substrate is saturated, drainage holes are created in the circumferential wall of the bag in order to define a maximum volume. Water exceeding the maximum volume will then drain from the bag via the drainage holes into the gutter. The known system further comprises a plurality of drippers, each dripper providing liquid nutrition droplets to the plant. Any liquid provided by the irrigation means and exceeding the maximum volume drains from the holding body onto the gutter.

Although the known system is useful for growing plants, there is still room for improvement. The development of a plant is for a substantial part dependent on the conditions of its roots. These roots are dependent on many different variables, such as temperature, amount of oxygen provided to the roots, humidity, degree and distribution of fertilization. Due to fluctuations in these variables, it is difficult to ensure that the roots of the plants in the plant growth system are exposed to a desirable environment. Especially in plant growth systems comprising many plants, it is difficult to ensure that each plant is exposed to a similar environment, such that all plants are equally treated. It is thus a problem of the state of the art that it is difficult to accurately control the plant growth, which results in sub-optimal plant growth.

Publication U.S. Pat. No. 4,630,394 describes an eb and flood growing system using growing tubes which are filled with gravel and which are provided with false bottoms over which a foraminous fabric strip is placed.

It is an object of the current invention to provide an improved growing environment wherein plant growth is more optimal and can be better controlled.

The object of the invention is reached with a system as disclosed in claim 1. Within the context of the current disclosure a growing substrate, or a plant growing substrate, is a dimensionally stable block comprising substrate material, in which the roots of a plant can grow. Such substrates are also referred to as slabs. Such substrates can be packaged in plastic foil or can be provided in an unpackaged condition in which latter case the substrates are referred to as being naked. The dimensional stability of the block can be the result of the bag-like package in which loose substrate material, such as cocopeat, is packaged but can also be the result of the texture of the substrate material which allows the substrate material to have a stable shape by its own. Relative terms such as “upper” or “below” or “higher” should be given its meaning in the context of the present disclosure while the plant growth system is in use.

The root barriers being provided below the upper side of the at least one bottom spacer, in combination with the use of the at least one bottom spacer provides the advantage that a spacing below the growing substrates is created which allows constant and complete drainage of the growing substrate thus preventing that the growing substrate becomes too wet. Furthermore said spacing allows air/oxygen to be present at the lower side of the growing substrates between the bottom and the growing substrate which feature is beneficial for the growth of the roots of the plants since it leads to a more arid environment for the roots to grow in. This furthermore allows continuous irrigation of the plants instead of intermittent irrigation. By providing for each holding body a water permeable root barrier, wherein each root barrier is positioned upstream of the common drainage, root growth in each holding body is limited, as the root barrier prevents the roots which grow in and through the growing substrates, from passing the root barrier and growing into the common drainage. The distance between the lower side of the growing substrate and the at least one root barrier preferably is at least 5 mm allowing a flow of air between the at least one root barrier and the lower side of the growing substrate as well as allowing space below the growing substrate for roots. The root barrier, which is positioned below the growing substrate, may for example be woven for example from polyester or metal fabric or may be perforated material. A root barrier is a barrier for preventing or at least limiting roots from passing it. However, in order to be water permeable, the barrier contains openings. The openings have a pore size which is too small for the roots of a plant to pass. However, the openings are big enough to let water through. The material of the root barrier should be such that it is able to withstand growing forces of the tip of a root which might increase the pore size in which case the roots would be able to pass the root barrier. At least together with the holding body, the root barrier substantially defines the area in which the roots can move freely. The use of a root barrier results in a growth environment wherein the roots of the plants are less susceptible to the environment, e.g. of a greenhouse, outside of the holding bodies, because the roots are less exposed to the environment outside of the holding bodies. Organisms such as bacteria, fungi, algae, flies, etc. which are residing outside of the holding bodies and might negatively influence the root growth, are less likely to reach the roots. Due to the root barrier, the roots are also less exposed to fluctuations in temperature, humidity and light from outside the holding body. This results in roots that are less susceptible to the environment outside of the holding bodies, which in turn leads to a more optimal plant growth. Moreover the roots of the plants are not exposed to water that has been in contact with other plants or at least not with plants the roots of which grow in growing substrates which are supported on bottom spacers of other holding bodies. Furthermore the water permeable nature of the root barrier allows water to flow through the root barrier. In practice it will often be favourable that the holding body has more than one bottom spacer to be able to properly support the growing substrate thereon and that at least one of the at least one bottom spacer extends from the bottom. The number of root barriers and drainage openings for each holding body may be one, but could also be more than one for instance two.

The at least one root barrier may be positioned in or downstream of the drainage opening which is in the bottom. This reduces the necessary surface of the root barrier.

In an embodiment the bottom of the holding body slopes towards the root barrier and/or towards the drainage opening. An advantage of this embodiment is that water is relatively easily guided to the drainage opening and out of the holding body. This reduces the chance that water, remains in the holding body, whereas its nutrition has already been depleted by the roots.

In an embodiment the root barriers have openings with a pore size ranging between 5 μm and 100 μm, preferably ranging between 10 μm and 75 μm. Surprisingly, the inventor found that a pore size smaller than 100 μm prohibits roots to penetrate the root barrier, because the openings are too small for the tip of the roots to settle in the opening and enlarge the opening as the roots grow bigger. However, in order to allow water to pass the root barrier, the pore size must be at least 5 μm. Preferably, the pore size ranges from 10 μm to 75 μm, because then a sufficient flow of water is ensured and chances the roots settle in the pores is reduced even further. The optimal pore size also depends on the type of plant.

In an embodiment the root barrier is mounted on a frame which surrounds the root barrier. The frame strengthens the root barrier. An advantage of this embodiment is that the root barrier is more resistant to damage, for instance, inflicted during placement of a plant in the interior volume, or as a result of force exerted by the roots in the holding body. Furthermore, replacement of the root barrier is easier, as the root barrier can be handled more easily.

In an embodiment the frame with the mounted root barrier is detachably connected to the holding body such as typically to its bottom. An advantage of this embodiment is that a holding body with an integrated root barrier is provided, wherein the system can be easily assembled. A further advantage of this embodiment is that the root barrier can easily be replaced without the necessity of replacing the complete associated holding body.

In an embodiment the frame may comprise a further bottom spacer which is aligned with the at least one bottom spacer. This way also a distance/space between the root barrier and the lower side of the growing substrate in the area directly above the root barrier can be assured.

In an embodiment the root barrier has at least substantially the shape of a circle. An advantage of this embodiment is that the root barrier can relatively easily be produced.

In an embodiment the root barrier has a surface ranging between 20 cm² and 500 cm², preferably ranging between 25 cm² and 100 cm² or ranging between 200 cm² and 450 cm². An advantage of this embodiment is that water is easily drained from the holding body. The optimum size of the surface will amongst others depend on the position of the root barrier in the system.

In an embodiment the drainage opening has a surface ranging between 1 cm² and 100 cm², preferably ranging between 5 cm² and 50 cm². An advantage of this embodiment is that the drainage opening is large enough to let water provided by the irrigation means easily pass.

In an embodiment the surface of the root barrier ranges between 15% and 85% of the surface of the bottom, preferably between 25% and 75% of the surface of the bottom. This provides space on the bottom for other elements than the root barrier such as in particular the at least one bottom spacer.

In an embodiment the drainage means comprise a reservoir directly downstream of the root barrier and having a further bottom in which a further drainage opening is provided. The further bottom of the reservoir is preferably sloping towards the further drainage opening. The reservoir acts as a buffer for guiding away the water. An advantage of this embodiment is that a more continuous flow of water out of the holding body is realized. With the sloping further bottom, water is easily drained from the holding body and gathered downstream.

According to a further embodiment the system also has a circumferential wall extending from the bottom. The circumferential wall reduces the amount of light and dust which could enter the space below the growing substrate and above the bottom of the holding body. Furthermore the circumferential wall may aid in correctly positioning the growing substrate on the at least one bottom spacer as well in the prevention that roots grow outside the holding body.

From a production point of view it may be favourable that the circumferential wall is an integral part of the holding body.

In an embodiment the upper edge of the circumferential wall is at a higher level than the upper side of the at least one bottom spacer. In that case the upper edge of the circumferential wall is at a greater distance from the bottom than the upper side of the at least one bottom spacer. In particular in such an embodiment entrance of light into the space below the growing substrate and the growing of the roots outside the holding body can be limited. The upper edge of the circumferential wall preferably is positioned at most 30 mm higher than the upper side of the at least one bottom spacer in which case the holding body can have a tray-like design which facilitates the cleaning of the holding body.

With the above mentioned embodiments related to the system having a circumferential wall, each holding body has an interior volume for accommodating at least a part of a growing substrate therein, the interior volume at least party being defined by the bottom and the circumferential wall. Roots of plants growing in said at least a part of a growing substrate as well as roots of plants as far as present below the growing substrate can consequently also be considered to be growing in the interior volume of the holding body.

In an embodiment the holding body comprises at least one wall spacer extending inwards from the circumferential wall for maintaining a, horizontal, distance between the circumferential wall and a growing substrate in the interior volume. The at least one wall spacer allows air with oxygen to flow downwards between a vertical side of a growing substrate positioned on the holding body, more in particular on the bottom spacers thereof, and the circumferential wall. This results in a more suitable growing environment for the plant, more in particular for the roots of the plant.

In an embodiment the holding body is made from a plastic material, preferably chosen from the group consisting of expanded polystyrene (EPS), polyethylene (PE), polypropylene (PP) or polylactid acid (PLA). An advantage of this embodiment is that the holding body is relatively cheap to produce. Furthermore such materials have advantageous insulating properties.

The holding body may be made by injection moulding allowing a large scale of production.

In an embodiment the system comprises a cover which is positioned on a holding body, preferably on a circumferential wall thereof, for covering an interior volume associated with the holding body, wherein the cover comprises an opening for receiving a propagation substrate with a plant growing therein. An advantage of this embodiment is that the interior volume and consequently the growing substrate and the roots are more secluded from the external environment.

The cover may be made by vacuum moulding which not only allows a large scale of production but also a relatively cheap production.

In an embodiment the cover comprises two cover parts which together from the opening in the cover. The roots of the plant in the holding body tend to, during the growth process, expand in the interior volume. It is thus possible that, at the end of the growth process in the holding body, the roots do not fit through the opening in the cover. By providing a two-part cover, it is possible to remove a plant from the cover more easily. A cover with two cover parts also enable an easy removal of the cover despite the presence of a plant.

In a further embodiment the cover comprises at least an upper part of a circumferential wall of the system. This allows the holding body to have a limited height and to be tray-like so that it can also easily be used with traditional growing substrates.

In an embodiment the common drainage comprises a closed conduit. In this embodiment the water is less influenced by the environment of the holding body, in particular since light and dust can not reach the water. Flies and algae can thus not easily grow near the common drainage, which leads to a cleaner environment near the holding body.

In an embodiment the closed conduit is in communication with each of the drainage openings via closed sub-conduits. An advantage of this embodiment is that water is guided from the holding bodies, wherein little or even no contact with the outside environment, in particular with light and dust, is ensured.

In an embodiment the irrigation means comprise irrigation elements which each are configured to provide water to the roots of a single plant. This allows a very efficient irrigation.

The irrigation means may comprise irrigation elements which each are configured to provide water to the roots of a plant via the upper side of the growing substrate in which the roots of the plant are growing. Water enters the growing substrate from the top side thereof and leaves the growing substrate from the lower side thereof. This allows a very well controlled irrigation.

The irrigation elements may comprise drippers. These drippers may be postioned in propagation substrates which are supported on the growing substrates.

In an embodiment the irrigation means comprise a common water supply for supplying water to the irrigation elements. An advantage of this embodiment is that it is possible to more equally provide nutrition to each of the growing substrates, such that each plant in the system is more accurately provided with nutrition.

In an embodiment the common drainage and the common water supply are in communication with each other via a water recirculation system. Drainage water from the common drainage is provided to the common water supply.

Preferably the water recirculation system comprises a cleaning system which for instance comprises a filter, which is suitable for cleaning the drainage water. An advantage of this embodiment is that less water is spilled. Moreover, a closed system is provided, wherein the water supplied to the plants is more controlled and the risk of spreading diseases is reduced.

The irrigation means may furthermore comprise a water supply, such as a reservoir and piping for transporting water from the reservoir to the irrigation elements. The irrigation means may further comprise a pump for pumping the water from the water supply through the piping to the irrigation elements. Preferably, the irrigation means further comprise a nutrition reservoir and a mixing unit, for mixing nutrition with the water provided to the interior volume of the holding body.

In an embodiment the system comprises propagation substrates, each with a plant growing therein, each of which propagation substrates being positioned on top of a growing substrate. The growing substrate is suitable for providing a sturdy ground. In use, the roots in the propagation substrate can relatively easily extend to the growing substrate.

In a second aspect according to the invention, a method for growing plants is provided. In particular, but not exclusively, this second aspect relates to a method performed in a greenhouse, using the plant growth system according to the invention as described above. The method comprises the steps of:
a. providing a number of holding bodies each with an associated root barrier,
b. positioning growing substrates on the bottom spacers of the holding bodies,
c. positioning propagation substrates each having a plant growing therein on top of the growing substrates allowing the growth of the roots of the plants into the associated growing substrates,
d. providing an irrigation element for each propagation substrate for allowing the supply of water to the propagation substrate via the associated irrigation element,
e. bringing the drainage openings on the one hand and the common drainage on the other hand in communication with each other for allowing water supplied via the irrigation elements to the propagation substrate to drain via the drainage opening to the common drainage.
   An advantage of such method is that the plants are exposed to a more optimal growing environment. The advantages of such a method will be clear for the skilled person when reading above about the advantages of the plant growth system according to the invention. The plants of the system are therefore to a lesser extend exposed to the environment outside of the holding body. The plant or plants in the system are thereby less susceptible to the environment, which leads to a more optimal plant growth in the plant growth system. A plant can be provided and held steadily in place in the propagation substrate on top of the growing substrate. The plant is provided with a suitable ground, provided by the growing substrate, to grow in. Moreover, the roots of the plant can relatively easily extend into the growing substrate which leads to a more stable plant. Furthermore, the growing substrate may comprise nutrition. By providing a nutritious substrate to the plant, the plant is provided with a base amount of nutrition. This enables a more controlled plant growth.

In an embodiment the method further comprises the step of:
f. positioning a cover on the holding body, for covering an interior volume associated with the holding body, wherein the cover comprises an opening for receiving the propagation substrate. An advantage of this embodiment is that a substantial part of the plant and the roots of the plant, are more secluded from the environment outside of the interior volume. This leads to a more controllable environment within the interior volume of the holding body.

According to a third aspect, a greenhouse is provided with the system according to the invention. An advantage of this aspect is that a relatively easily controllable environment is provided wherein the holding bodies are present. It is thus possible to control the environment directly outside of the holding bodies, wherein temperature is more easily kept stable. This leads to a better growing environment.

According to a fourth aspect, a holding body for use in the system according to the current invention is provided. The holding body has a bottom and at least one bottom spacer extending upwards from the bottom, the at least one bottom spacer being configured for supporting a growing substrate thereon such that a distance is maintained between the bottom and the growing substrate, the holding body further comprising a water permeable root barrier wherein each root barrier is positioned in the drainage opening or downstream of the drainage opening for allowing passing of water through the root barrier and through the drainage opening but preventing the roots from penetrating through the root barrier. An advantage of this aspect is that a holding body is provided allowing the roots of a plant to be more secluded. The roots are thus less influenced by variables that negatively affect the roots. This results in better plant growth.

According to a fifth aspect, a (plant) growing substrate for use in a system according to the current invention is provided. The growing substrate comprises a bag and substrate material within the bag, the material of the bag having openings with a pore size ranging from 100 μm² to 4000 μm², allowing plant roots to penetrate the material of the bag but preventing substrate material to pass through the material of the bag. An advantage of this embodiment is that the roots of the plant can steadily settle in the substrate material.

In an embodiment the substrate material is one or a combination of stonewool, or glasswool, organic fibres such as coir, peat or wood fiber. and/or polylactic acid.

In an embodiment the substrate material are beads of plastic material, preferably of polylactic acid (PLA). The inventor found that, when exposed to drops of water, the beads form a film of water at the exterior of the beads. This water film is easily accessible for plant roots to absorb. Also, the roots are less suffocated by the water, as oxygen can more easily reach the roots in between the beads. An advantage of this embodiment is, that a more optimal oxygen-water mixture is provided to the roots, which leads to a better growing environment for the roots.

### FIGURE DESCRIPTION

The invention will be further elucidated below on the basis of the description of several embodiments of plant growth systems, with reference to the following figures, in which:

FIG. 1 shows an isometric view of an embodiment of the plant growth system which is not according to the invention as claimed in the present application;

FIG. 2 shows an isometric view of an embodiment of the holding body for use in the plant growth system according to the invention;

FIGS. 3a and 3b show two vertical cross sections of the embodiment according to FIG. 2 which cross sections are perpendicular to each other;

FIGS. 4a, 4b and 4c respectively show an perspective exploded view, a top view and a side view of the drainage means for use in the holding body of the plant growth system according to FIG. 2;

FIG. 5 shows a schematic cross section of an embodiment of a holding body according to the present invention;

FIG. 6 shows a perspective view of an embodiment of a holding body according to the invention.

FIG. 7 shows the holding body according to FIG. 6 in combination with a growing substrate;

FIG. 8 shows the holding body of FIG. 6 in combination with a growing substrate and a cover;

FIG. 9 shows a side view of the embodiment of the holding body shown in FIG. 8;

FIG. 10 shows a vertical cross sectional view of the holding body shown in FIG. 8 or 9;

FIG. 11 shows a cross sectional view of a couple of holding bodies which are stacked;

FIG. 12 shows in isometric view a root barrier to be used in combination with the holding body as shown in FIG. 6.

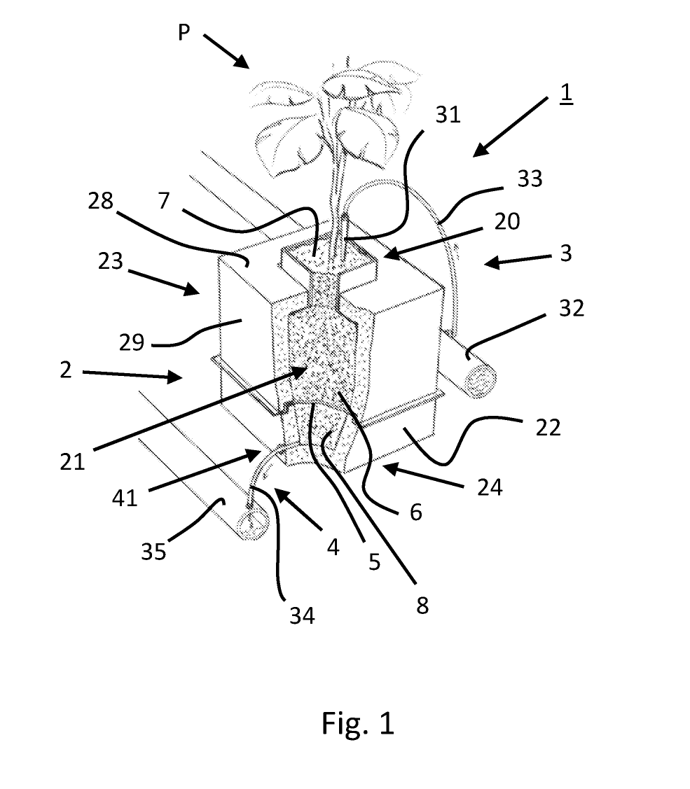

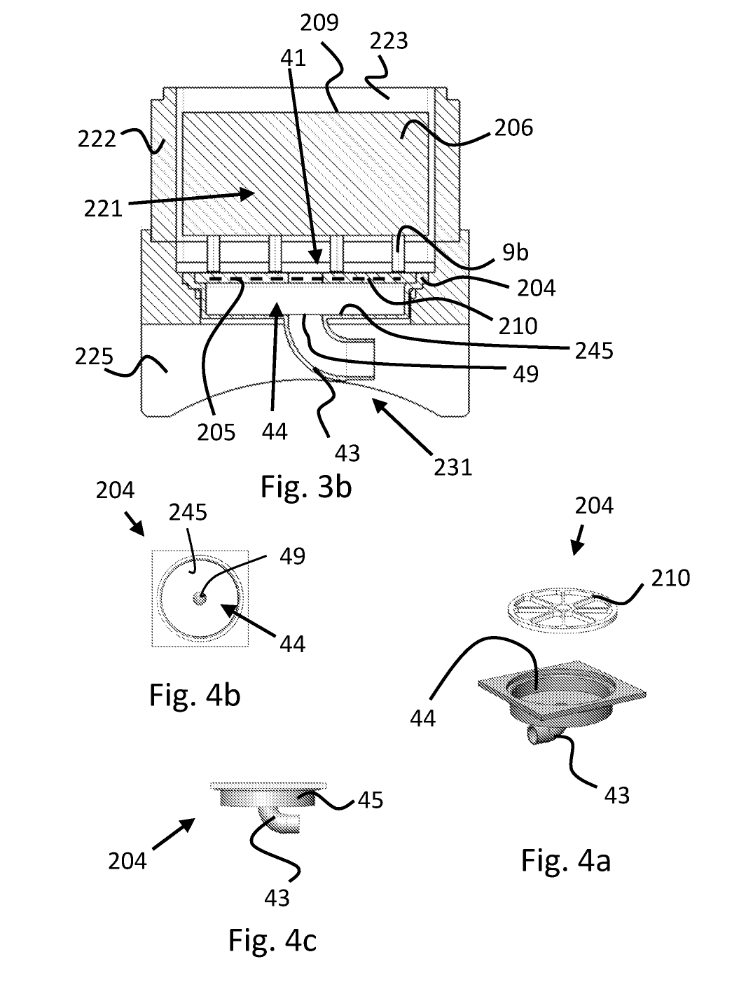

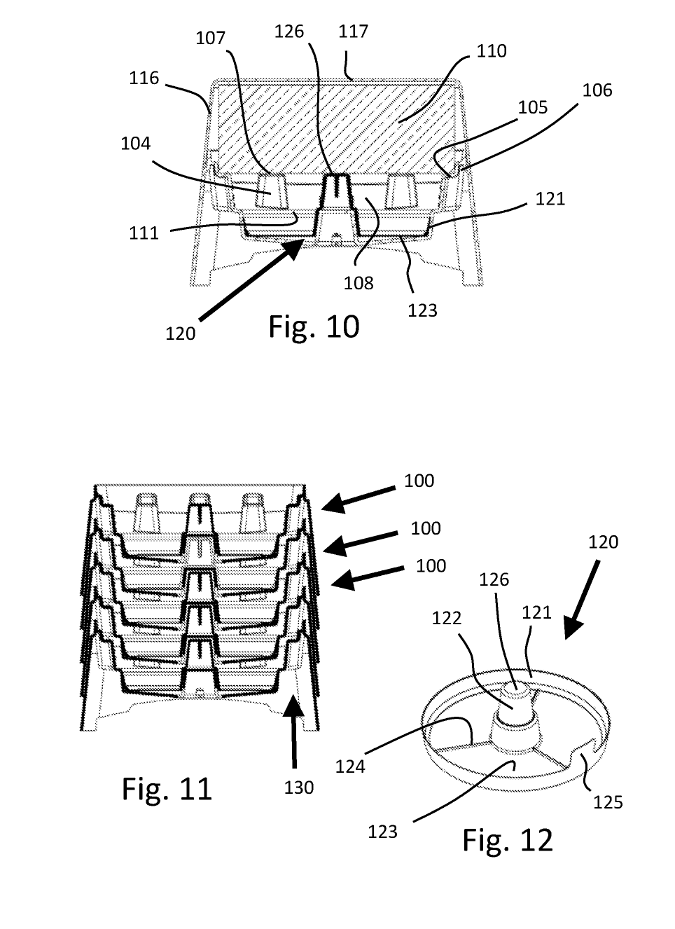

FIG. 1 depicts an embodiment of a plant growth system 1 which is not according to the invention. Its present description is however considered usefull to properly understand and appreciate the invention to which FIGS. 3 to 12 relate.

The plant growth system 1 comprises a box 2. The box includes a lower part having a circumferential wall 22 and a bottom 24. Together with the bottom 24, the circumferential wall 22 defines a lower part of an interior volume 21 of the box 2. The box 2 further comprises a cover 23 with a cover plate 28 and a circumferential wall 29 which extends downwardly from the circumference of the cover plate 28. This circumferential wall 29 is aligned with the circumferential wall 22. In the centre of the cover plate a square opening 20 is provided. The holding body 2 is made from a plastic material, such as expanded polystyrene (EPS), polyethylene (PE), polypropylene (PP), or polylactic acid (PLA).

Near the bottom 24 of the box 2 a drainage opening 41 is provided in the circumferential wall 22. The drainage opening 41 connects to a common drainage embodied as a pipe 35 via a tube 34.

The box 2 is further provided with a cloth-like root barrier 5 which is clamped between the circumferential wall 22 and the circumferential wall 29. The root barrier 5 has mesh openings with a pore size of for instance 50 μm or 70 μm. Such pore size allows the passage of water through the root barrier 5 but prevents the passage of roots. The root barrier 5 divides the interior volume 21 of the box 2 in an upper part and a lower part. In the upper part substrate material 6 is provided whereas in the lower part a further substrate material 8 is provided. The further substrate material 8 supports the growing substrate and prevents the root barrier 5 to sag under the influence of the weight of the substrate material 6. Substrate material 6 can comprise mineral or glass wool, but can also comprise plastic beads such as made from expanded polystyrene (EPS).

A propagation substrate 7, shaped as a stable block, is positioned on top of the growing substrate 6, more in particular at the location of opening 20 of cover plate 28. A plant P is growing in the propagation substrate 7. The positioning of the propagation substrate 7 on top of the growing substrate 6 allows the roots of the plant P to grow into the substrate material 6.

The system 1 comprises irrigation means 3 comprising irrigation elements embodied as dripper 31 for supplying water, possibly containing nutrition, to the roots of the plant P in the substrate material 6 in the interior volume 21 via the upper side of the propagation substrate 7 and via the upper side of the substrate material 6. The dripper 31 is positioned in the propagation substrate 7 and configured to release drops of water in the propagation substrate 7. At the upper end the dripper 31 is connected via a tube 33 to a common water supply embodied as a pipe 32.

In use boxes 2 will typically rest on the elevated, flat, middle part of a gutter having an Ω-shaped vertical cross section. The pipes 32 and 35 will rest on the lowered opposite parts of the Ω-shape and are part of a closed circuit which prevents light and dust being able to reach the water within the circuit.

In practise, water from the dripper 31 will travel downwards through the propagation substrate 7 and the substrate material 6 in the interior volume 21. The roots of plant P can absorb this water. Also, when nutrition is provided by the dripper 31, the roots can absorb this nutrition. It is also possible that the propagation substrate 7 and/or the substrate material 6 comprises nutrition which is added to the water as supplied via the dripper 31.

The water provided by the dripper 31 will pass the root barrier 5 as it travels through the substrate material 6 and the further substrate material 8. When water reaches the drainage opening 41, it is guided out of the holding body 2 via tube 34. The root barrier is water permeable, which means that the root barrier is suitable for allowing water to pass the barrier 5. However, the roots of plant P cannot pass the root barrier 5. The root barrier 5 is positioned upstream of the drainage opening 41. This way it is prevented that roots grow into the drainage opening 41, or into the tube 34 or the common drainage pipe 35. This could lead to an obstruction for the water flow and would likely disturb the growing process of plant P.

Although FIG. 1 only shows one box 2, in practice the system will comprise a number of similar boxes 2 which each are in communication with the common drainage pipe 35 and the common water supply pipe 32.

The system 1 as shown in FIG. 1 and as described above is not according to the invention since it does not comprise holding bodies each with at least one bottom spacer extending upwards from the bottom of the holding body and since it does not comprise a root barrier which is positioned in or downstream of the drainage opening. Other aspects of the present invention however are embodied in the system 1.

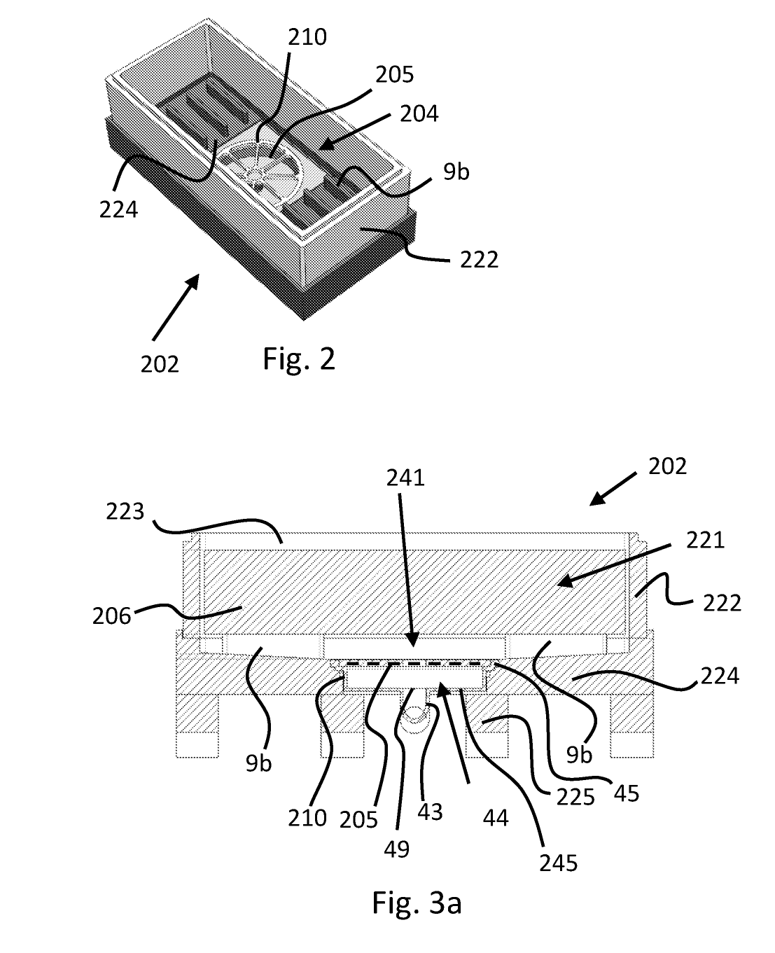

FIGS. 2 to 4c relate to a holding body 202. The holding body 202 can be used in a plant growth system according to the current invention. Holding body 202 is made from different components. The bottom 224 is connected with the circumferential wall 222. Bottom 224 and wall 222 could however also be one integral part. The bottom 224 and the wall 222 define a interior volume 221 having an open upper side 223 on which a cover may in use be placed. In use the interior volume 221 accommodates a growing substrate 206.

A root barrier unit 204 which has a square circumference in top view, is provided in a drainage opening 241 in the bottom 224 of the holding body 202. To this end, a square recess is provided in the bottom 224 the upper side of which constitutes the drainage opening 241. The root barrier unit 204 is provided with a reservoir 44 (FIGS. 3a and 3b). A circular frame 210 is shape fitted received in a further circular recess in the basically rectangular frame of the root barrier unit 203. The root barrier unit 204 further comprises a further drainage opening 49 in the further bottom 245 of the reservoir 44 via which an elbow pipe 43 is communicatively connected to reservoir 44. In use the elbow pipe 43, like elbow pipes 43 associated with other holding bodies 202, will be communicatively connected with its downstream end to a common drainage pipe like drainage pipe 35 forming part of a closed recirculation circuit. A root barrier 205 is mounted to the frame 210. The frame 210 is connected to the rectangular frame of the root barrier unit 204 in such a way that the drainage opening 241 is closed off for the roots of a plant.

The holding body 202 further comprises a base frame 225. The base frame 225 is provided underneath the bottom 224 and serves as a support. The base frame 225 is suitable for keeping the holding body 202 stably in place. FIG. 3a shows that the bottom 224 slopes towards the drainage opening 241 and bottom spacers 9b which extend upwards from the bottom 224. In use, the spacers 9b provide a space between a growing substrate 206 and the bottom 224. The upper surfaces of the spacers 9b are substantially flat and aligned with, or in other words flush to, each other such that a growing substrate 206 can rest on the spacers 9b.

The base frame 225 comprises an arc-shaped recess at its lower side as shown in FIG. 3b. The arc-shaped recess 231 is suitable to engage with a flat support, such as the elevated middle part of a gutter having an Ω-shaped vertical cross section, having a width which is smaller than the arc-shaped recess. In case the support would not be perfectly horizontal the arc-shaped recess 231 provides a means for compensating this such that the holding body 202 is oriented as desired.

The frame 210 is provided with a root barrier 205. The reservoir 44 has a rectangular cross section. However, it is also possible that the reservoir 44 is funnel shaped, wherein the further bottom 245 of the reservoir 44 is sloping towards the elbow pipe 43.

FIGS. 4a to 4c show different views of the root barrier unit 204 including in FIG. 4a with frame 210. The root barrier unit 204 is provided in a recess in the bottom 224 of the holding body 202.

In use, water which is being irrigated by drippers via the upper side 209 of the growing substrate 206, flows downwards through the root barrier 205, into the reservoir 44. Water is, temporarily, collected in the reservoir 44, after which the water continues through the opening 49 in the bottom 245 of the reservoir 44 and into the elbow pipe 43 and further to a common drainage pipe. The root barrier 205 is flat and is circle-shaped. Also, frame 210 comprises a circle shaped cross section. In this embodiment, the frame 210 with the root barrier 205 mounted thereon is detachably connected to the holding body 202. Although not shown in the figure, the reservoir may be funnel-shaped, the further bottom 245 sloping towards the further drainage opening 49 such that water is easily guided to the elbow pipe 43.

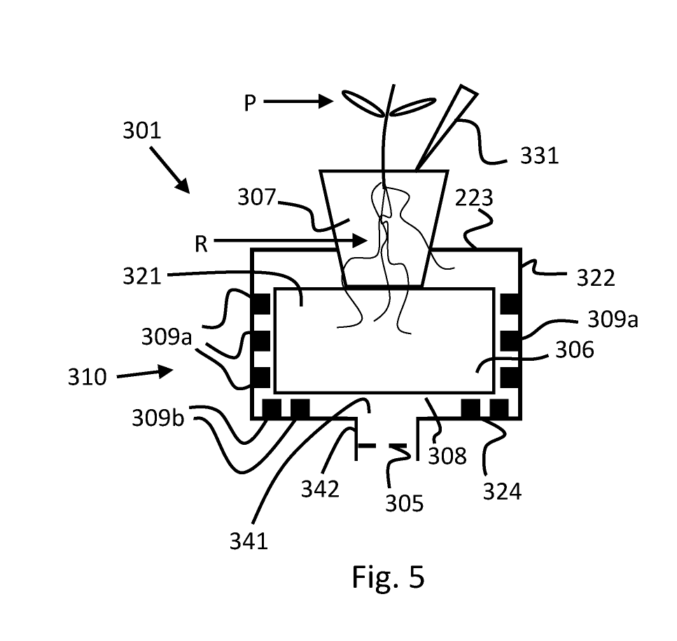

FIG. 5 shows a cross sectional view of a plant growth system 301. A first multitude of side spacers 309a is adjacent to the circumferential wall 322 of the holding body 301. The side spacers 309a extend between the plant growing substrate 306 and the circumferential wall 322. The holding body 301 also comprises bottom spacers 309b which extend upwards from the bottom 324 of the holding body 302. The spacers 309b extend in the interior volume 321 of the holding body 302 which interior volume 321 is defined by the bottom 324 and the wall 322. Within the interior volume 321 a growing substrate 306 is accommodated while being supported on the bottom spacers 309b. The side spacers 309a ascertain a distance between the circumferential wall 322 and the plant growing substrate 306 and are configured such that air can flow in a vertical direction along the side spacers 309a to the space 308 below the lower side of the growing substrate 306 and the bottom 324. This space 308 is present because of bottom spacers 9b which support the growing substrate 306 and create a distance and space between the bottom 324 and the plant growing substrate 306. The growing substrate 306 support a propagation substrate 307 with a plant P. A dripper 331 is stuck in the propagation substrate 307. The roots R of the plant P grow both in the propagation substrate 307 as well as in the growing substrate 306.

The holding body 302 comprises a cover 223. The cover 323 may be connectable to the circumferential wall 322, for instance using a snap connection. The cover 323 covers the open upper side of the holding body 302. The cover 323 comprises an opening for receiving the substrate block 307 with the plant P growing therein onto the plant growing substrate 306.

In the bottom 324 a drainage opening 341 is provided which connects to a drainage pipe 342. Within the pipe 342 below the drainage opening 341 a root barrier 305 is provided. Downstream of the root barrier 305 the pipe 342 connects to a common drainage pipe just like other pipes 342 of other holding bodies 302.

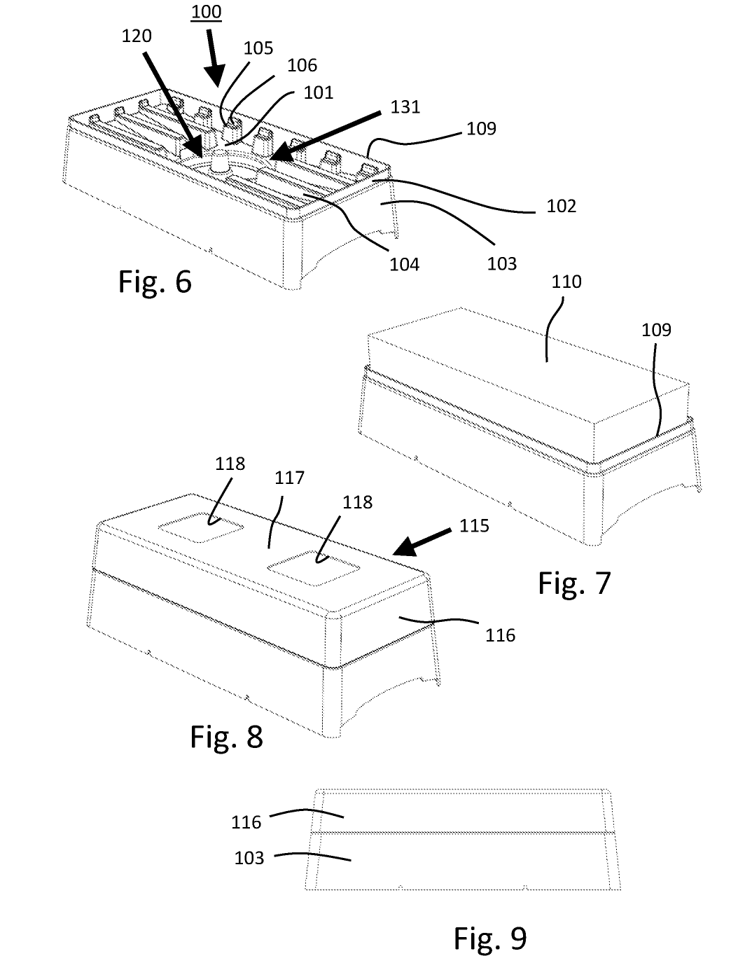

FIGS. 6 to 12 relate to a system with another holding body 100. The holding body 100 is tray-like. The holding body 100 comprises a bottom 101 and a circumferential wall 102 that together define a part of an interior volume. The bottom 101 is provided with an opening 131 for receiving a root barrier frame 120 (FIG. 12) with a root barrier 123 mounted thereon. The tray-like holding body 100 further comprises a base frame 103 at its lower side.

The holding body 100 is provided with bottom spacers 104, 105 above bottom 101 and side spacers 106. Bottom spacers 104 are substantially free from the circumferential wall 102.The bottom spacers 105 extend substantially adjacent the circumferential wall 102. In use the respective upper sides of the spacers 104, 105, which are aligned with each other, support a growing substrate. The side spacers 106 are connected to the bottom spacers 105, and have a vertical positioning surface at a short distance from the circumferential wall 102. When a growing substrate 110 is positioned on the holding body 100, the bottom spacers 104, 105 support the growing substrate 110 such that a vertical distance is maintained between the lower side of the growing substrate 110 and the bottom 101. The side spacers 106 ensure that a horizontal distance is maintained between the vertical sides of the growing substrate 110 and the circumferential wall 102. The upper edge 109 of the circumferential wall 102 is located for instance 20 mm above the upper sides of the bottom spacers 104, 105 reducing the amount of light and dust which in use enters the space 108 between the bottom 101 and the lower side of the growing substrate 110.

A cover 115 can be positioned onto the holding body 100, more in particular on the circumferential wall 102 thereof. The cover 115 comprises a base plate 117 and a circumferential wall 116 extending downwards from said base plate 117. A shape fitting connection may be used between the holding body 100 and the cover 115. The circumferential wall 116 of the cover 115 defines the interior volume of the holding body 100 together with the circumferential wall 102 of the holding body 100.

The cover 115 comprises two openings 118 in the base plate 117. In these openings 118 a propagation substrate (not visible) can be positioned on top of the growing substrate 110.

A root barrier frame or unit 120 is positioned in a circular drainage 111 opening in the bottom 101 of the holding body 100. The root barrier frame 120 comprises a circular outside wall 121 which is connected via ribs 124 to a root barrier bottom spacer 122 within the circumference of the circular outside wall 121. A root barrier 123 is mounted on the root barrier frame 120, between the root barrier bottom spacer 122 and the outside wall 121. The upper side of the root barrier bottom spacer 122 is aligned with the upper sides of the bottom spacers 104. In use, the substrate 110 tends to loose some stiffness due to the usage of the substrate 110. The root barrier spacer 122 supports the substrate 110 above the root barrier 123 in order to prevent the substrate 110 from sinking towards the root barrier 123.

The outside wall 121 is designed such to provide a shape fitted watertight connection with the drainage opening in the bottom 101. At the outside wall 121 an engagement portion 125 is provided. When the root barrier frame 120 is assembled with the holding body 100, the engagement portion 125 extends upwards from the bottom 101 wherein the engagement portion 125 is free from the bottom 101 such that the engagement portion 125 can be grabbed by a person to remove the root barrier frame 120 from the bottom 101 of the holding body 100.

The tray-like holding bodies 100 are stackable. This is shown with more detail in FIG. 11. Each holding body 100 comprises a hollowed bottom structure 130 at an underside of the holding body 100. Because each of the tray-like holding bodies 100 has a similar hollowed bottom structure, the trays can be stacked on top of each other.

The following clauses define several aspects and embodiments of the invention:
1. Plant growth system comprising
a number of holding bodies each having a bottom and a circumferential wall extending from the bottom, as well as an interior volume for accommodating at least the roots of at least one plant, the interior volume at least party being defined by the bottom and the circumferential wall,
irrigation means for supplying water to plants of which at least the roots are accommodated in the interior volumes of the respective holding bodies,
drainage means having a drainage opening in the bottom or circumferential wall of each holding body as well as a common drainage which is in communication with each of the drainage openings for allowing water supplied by the irrigation means to the plants to drain via the drainage opening from the interior volume of the holding body to the common drainage,
characterized in that
the system further comprises a water permeable root barrier for each holding body wherein each root barrier is positioned upstream of the common drainage for allowing passing of water through the root barrier and through the drainage opening but preventing roots in the interior volume of an associated holding body from penetrating through the root barrier in the common drainage.
2. Plant growth system according to clause 1, wherein the root barriers are positioned in the interior volume of the respective associated holding bodies.
3. Plant growth system according to clause 1, wherein the root barriers are positioned in the drainage opening of the respective associated holding bodies.
4. Plant growth system according to clause 1, wherein the root barriers are positioned downstream of the drainage opening of the respective associated holding bodies.
5. Plant growth system according to any of the preceding clauses, wherein the root barriers have openings with a pore size ranging between 5 μm and 100 μm, preferably ranging between 10 μm and 75 μm.
6. Plant growth system according to any of the preceding clauses, wherein the root barrier is mounted on a frame which surrounds the root barrier.
7. Plant growth system according to clause 6, wherein the frame with the mounted root barrier is detachably connected with or integrated to the holding body, preferably with or to the bottom of the holding body.
8. Plant growth system according to any of the preceding clauses, wherein the root barrier has at least substantially the shape of a circle.
9. Plant growth system according to any of the preceding clauses, wherein the root barrier has a surface ranging between 20 cm2 and 500 cm2, preferably ranging between 25 cm2 and 100 cm2 or ranging between 200 cm2 and 450 cm2.
10. Plant growth system according any of the previous clauses, wherein the drainage opening has a surface ranging between 1 cm2 and 100 cm2, preferably ranging between 5 cm2 and 50 cm2.
11. Plant growth system according to any of the previous clauses, wherein the root barrier is provided in the bottom of the holding body
12. Plant growth system according to clause 11, wherein the surface of the root barrier ranges between 25% and 75% of the surface of the bottom.
13. Plant growth system according to clause 11 or 12, wherein the bottom of the holding body slopes towards the root barrier and/or towards the drainage opening.
14. Plant growth system according to any of the previous clauses, wherein the drainage means comprise a reservoir directly downstream of the root barrier and having a bottom in which the drainage opening is provided, the bottom of the reservoir preferably sloping towards the drainage opening.
15. Plant growth system according to any of the previous clauses, wherein the holding body comprises at least one wall spacer extending inwards from the circumferential wall for maintaining a distance between the circumferential wall and a growing substrate in the interior volume.
16. Plant growth system according to any of the previous clauses, wherein the holding body comprises at least one bottom spacer extending upwards from the bottom for maintaining a distance between the bottom and a growing substrate in the interior volume.
17. Plant growth system according to any of the previous clauses, wherein the circumferential wall of the holding body is formed out of a rigid material.
18. Plant growth system according to any of the previous clauses, wherein the holding body is made from a plastic material, preferably chosen from the group consisting of expanded polystyrene (EPS), polyethylene (PE), polypropylene (PP) or polylactic acid (PLA).
19. Plant growth system according to any of the previous clauses, wherein the holding body comprises a cover which is to be positioned on the circumferential wall for covering the interior volume of the holding body, wherein the cover comprises an opening for receiving a propagation substrate with a plant growing therein.
20. Plant growth system according to clause 19, wherein the cover comprises two cover parts which together from the opening in the cover.
21. Plant growth system according to any of the previous clauses, wherein the common drainage comprises a closed conduit.
22. Plant growth system according to clause 21, wherein the closed conduit is in communication with each of the drainage openings via closed sub-conduits.
23. Plant growth system according to any of the previous clauses, wherein the irrigation means comprise a common water supply for supplying water to a plurality of irrigation elements, wherein each irrigation element is suitable for providing water to a plant of which at least the roots are accommodated in the interior volumes of the respective holding bodies.
24. Plant growth system according to clause 23, wherein the common drainage and the common water supply are in communication with each other via a water recirculation system.
25. Plant growth system according to any of the preceding clauses, wherein the system comprises plant growing substrates which are accommodated in the interior volumes of the respective holding bodies.
26. Plant growth system according to any of the preceding clauses, wherein the system comprises propagation substrates each with a plant growing therein which propagation substrates are positioned at the upper side of the interior volumes of the respective holding bodies.
27. Method for growing plants, in particular but not exclusively performed in a greenhouse, using the plant growth system according to any of the previous clauses, comprising the steps of:
a. providing a number of holding bodies each with an associated root barrier,
b. positioning propagation substrates each having a plant growing therein at the upper side of the interior volumes of the respective holding bodies allowing the growth of the roots of the plants into the associated respective interior volumes,
c. providing an irrigation element for each propagation substrate for allowing the supply of water to the propagation substrate via the associated irrigation element,
d. bringing the drainage openings on the one hand and the common drainage on the other hand in communication with each other for allowing water supplied via the irrigation elements to the propagation substrate to drain via the drainage opening from the interior volume of the associated holding body to the common drainage,
28. Plant growing method according to clause 27, wherein the method further comprises the step of:
e. before step b. placing a growing substrate in the interior volume of the holding body, and
f during step b. placing the propagation substrate on top of the growing substrate.
29. Plant growing method according to clause 27 or 28 wherein the method further comprises the step of:
g. providing a cover for covering the interior volume of the holding body.
30. Greenhouse provided with the system according to any of the clauses 1 to 26.
31. Holding body for use in the system according to any of the clauses 1 to 26, having a bottom and a circumferential wall extending from the bottom, as well as an interior volume for accommodating at least the roots of at least one plant, the interior volume at least party being defined by the bottom and the circumferential wall, a drainage opening being provided in the bottom or circumferential wall which drainage opening is to be brought into communication with a common drainage downstream of the drainage opening, the holding body further having a water permeable root barrier for allowing passing of water through the root barrier and through the drainage opening but preventing roots in the interior volume of an associated holding body from penetrating through the root barrier in the common drainage, the root barrier being positioned in the interior volume or in the drainage opening of the holding body.
32. Plant growing substrate for use in a system according to any of the clauses 1 to 26, comprising a bag and substrate material within the bag, the material of the bag having openings with a pore size having a surface ranging from 100 μm² to 4000 μm², allowing plant roots to penetrate the material of the bag but preventing substrate material to pass through the material of the bag.
33. Plant growing substrate according to clause 32, wherein the substrate material is one or a combination of stonewool, glasswool, wood fiber and/or polylactic acid.
34. Plant growing substrate according to clause 32 or 33, wherein the substrate material are beads of plastic material, preferably of polylactic acid.
35. Use of a plant growth system according to any of the clauses 1 to 26 for growing plants.

1. A plant growth system comprising:
a growing substrate as configured to receive roots of growing plants;
a holding body having a bottom surface and at least one bottom spacer having an upper surface supporting the growing substrate thereon such that the bottom surface and the growing substrate are separated by a distance;
an irrigation means for supplying water to the growing substrates;
a drainage means having a drainage opening defined in the bottom surface and in communication with a common drainage for allowing water supplied by the irrigation means to the growing substrate to drain via the drainage opening to the common drainage; and
a water permeable root barrier disposed in the holding body wherein the root barrier is positioned below the upper surface of the at least one bottom spacer and upstream of the common drainage for allowing passing of water through the root barrier to the common drainage while preventing the roots from penetrating through the root barrier into the common drainage.

2. The plant growth system according to claim 1, wherein the root barrier is positioned in or downstream of the drainage opening.

3. The plant system according to claim 2, wherein the bottom surface of the holding body slopes towards one of the root barrier or the drainage opening.

4. The plant growth system according to claim 3, wherein the root barrier has openings with a pore size from about 5 μm and to about 100 μm.

5. The plant growth system according to claim 1, wherein the root barrier is mounted on a frame which surrounds the root barrier such that the frame with the root barrier is detachably connected to the holding body and wherein the frame includes an additional bottom spacer which is aligned with the at least one bottom spacer.

6. (canceled)

7. (canceled)

8. The plant system according to claim 1, wherein the root barrier has a substantially circular shape.

9. The plant system according to claim 1, wherein the root barrier has a surface area from about 20 cm² to about 500 cm², the drainage opening has a surface area from about 1 cm² to about 100 cm², and the root barrier has a surface area from about 15% to about 85% of the surface area of the bottom surface.

10. (canceled)

11. (canceled)

12. The plant growth system according to claim 1, wherein the drainage means further includes a reservoir directly downstream of the root barrier and having an additional bottom surface with an additional drainage opening, the additional bottom surface slopes towards the additional drainage opening.

13. (canceled)

14. The plant growth system according to claim 1, further comprising a circumferential wall extending from the bottom surface, the circumferential wall is integrally formed with the holding body and includes an upper edge that is at a higher level than the upper surface of the at least one bottom spacer the bottom surface, and the circumferential wall define an interior volume configured to accommodate at least a portion of the growing substrate, wherein the holding body further includes at least one wall spacer extending inwards from the circumferential wall configured to maintain a horizontal distance between the circumferential wall and at least the portion of the growing substrate disposed in the interior volume.

15-18. (canceled)

19. The plant growth system according to claim 1, wherein the holding body is made by injection moulding from a polymer material selected from the group consisting of an expanded polystyrene (EPS), a polyethylene (PE), a polypropylene (PP), a polylactic acid (PLA) and combinations thereof.

20. (canceled)

21. The plant growth system according to claim 14, further comprising a cover positioned on the holding body and configured to cover an interior volume defined by the holding body, wherein the cover comprises an opening for receiving a propagation substrate with a plant growing therein.

22. The plant growth system according to claim 21, wherein the cover is made by vacuum moulding, wherein the cover forms at least an upper part of the circumferential wall and includes two cover parts which define the opening in the cover.

23. (canceled)

24. (canceled)

25. The plant growth system according to claim 1, wherein the common drainage includes a closed conduit which is in communication with the drainage opening via a closed sub-conduit.

26. (canceled)

27. The plant growth system according to claim 1, wherein the irrigation means includes irrigation elements configured to provide water to the roots of a single plant through the upper surface of the growing substrate.

28. (canceled)

29. The plant growth system according to claim 27, wherein the irrigation means
a water supply;
piping for transporting water from the water supply to the irrigation elements;
a pump for pumping the water from the water supply through the piping to the irrigation elements;
a nutrition reservoir coupled to the water supply; and
a mixing unit configured to mix nutrition with the water in the nutrition reservoir provided to irrigation elements.

30. (canceled)

31. (canceled)

32. The plant growth system according to claim 29, wherein each of the irrigation elements includes a dripper.

33. (canceled)

34. The plant growth system according to claim 32, wherein the common drainage and the water supply are in communication with each other via a water recirculation system having a cleaning system for cleaning water from the common drainage.

35. (canceled)

36. The plant growth system according to claim 1, further comprising a propagation substrate positioned on top of the growing substrate.

37. (canceled)

38. Method for growing plants, comprising:
positioning a growing substrate on a bottom spacer of a holding body having a root barrier;
positioning a propagation substrate each having a plant growing therein on top of the growing substrate allowing growth of roots of the plant into the growing substrate;
supplying water through an irrigation element to the propagation substrate and
connecting a drainage opening of the holding body with a common drainage to allow water supplied via the irrigation element to the propagation substrate to drain via the drainage opening to the common drainage.

39. The method according to claim 38, wherein the method further comprises:
positioning a cover on the holding body to cover an interior volume associated with the holding body, wherein the cover includes an opening for receiving the propagation substrate.

40. (canceled)

41. (canceled)

42. The plant growing system according to claim 1, wherein the growing substrate includes a bag and a substrate material disposed within the bag, the bag having openings with a pore size from about 100 μm² to about 4000 μm², allowing plant roots to penetrate the bag while preventing the substrate material to pass through the bag, wherein the substrate material is selected from the group consisting of stonewool, polymeric beads, glasswool, organic fiber, coir, peat, wood fiber, polylactic acid, and combinations thereof.

43-45. (canceled)
